(19) United States
(12) Patent Application Publication
(10) Pub. No.: US 2011/0313662 A1
(43) Pub. Date: Dec. 22, 2011

(54) NAVIGATION APPARATUS AND SYSTEM

(75) Inventors: Jiung-Yao Huang, Taoyuan (TW); Chung-Hsien Tsai, Chia Yi (TW); Yi-Fan Li, Taipei (TW)

(73) Assignee: Jiung-Yao Huang, Taoyuan City (TW)

(21) Appl. No.: 12/891,896

(22) Filed: Sep. 28, 2010

(30) Foreign Application Priority Data
Jun. 22, 2010 (TW) 099120197

(51) Int. Cl. G01C 21/30

(52) U.S. Cl. 701/210; 701/208

(57) ABSTRACT

A navigation apparatus and system provided on a mobile carrier performs error correction for positioning information and orienting information of the carrier through a position sensing module and an orientation sensing module and analyzes the corrected positioning information and orienting information by the usage of a route planning module, so as to generate corresponding route planning information, while simultaneously showing an instruction label having the route planning information correspondingly and a real image of the location surrounding the carrier. Thereby, the invention may provide not only an accurate carrier positioning function but also correct navigation information according to the behavior mode of a user.

### BACKGROUND OF THE INVENTION

1. Field of the Invention

This invention relates to a navigation apparatus and system, and, more particularly, to an apparatus and system for simultaneously performing error correction and displaying a real image of the location surrounding a carrier of the apparatus.

2. Description of Related Art

Navigation apparatus performing positioning by the use of a global positioning system (GPS) is more and more popular as performance increases and prices drop. However, a problem exists in that a general navigation apparatus still exhibits low accuracy positioning and the display screen not presenting the correct orientation, etc.

The reason for the low accuracy positioning is that, since a satellite receiver is easily affected by the environment of a user, a drift error phenomenon can occur on the satellite receiver of the navigation apparatus receiving a satellite signal supplied by the GPS system. To overcome the problem, a magnetic compass or a gyroscope dynamically sensing orientation is provided on the navigation apparatus to decrease the incidence of error phenomenon according to orienting information supplied by the magnetic compass or the gyroscope. The operation principle of the magnetic compass or the gyroscope is related to Hall effect, that is, using Lorentz force to offset electrons and calculate voltage variation data, hence, dynamically detecting the orienting information. However, electron offset is easily affected by the electromagnetic environment of the user, hence using the magnetic compass or the gyroscope to decrease the incidence of error phenomenon still can't effectively and completely solve low-accuracy positioning problems.

### SUMMARY OF THE INVENTION

In view of the above-mentioned problems of the prior art, it is an objective of the present invention to provide a navigation apparatus and system for accurately performing positioning and rapidly estimating the subsequent route.

To achieve the above-mentioned and other objectives, a navigation apparatus is provided according to the present invention. The navigation apparatus is provided on a carrier. The navigation apparatus comprises a positioning module for receiving and analyzing positioning signals sent from satellites, so as to generate positioning information corresponding to the carrier, an orienting module for analyzing an electromagnetic signal in response to activities of the carrier, so as to generate orienting information corresponding to the carrier, a position sensing module for inferring the current behavior mode of the carrier and performing error correction for the positioning information of the carrier according to the behavior mode, an orientation sensing module for correcting the electromagnetic signals and performing cross validation for the corrected electromagnetic signals and the positioning information, so as to perform error correction for the orienting information of the carrier, a map database for providing map information, a data processing module for capturing a region map correspondingly from the map information according to the positioning information and the orienting information and generating a location tag corresponding to the carrier on the region map, and a display module for displaying the region map and presenting the positioning information, the orienting information, and/or the location tag on the region map.

Further, a navigation system is provided according to the present invention. The navigation system comprises a navigation apparatus, a map data server, and a waypoint server. The navigation apparatus provided on a carrier is used for providing position and navigation, wherein the navigation apparatus comprises a positioning module for receiving and analyzing positioning signals sent from satellites, so as to generate positioning information corresponding to the carrier, an orienting module for analyzing an electromagnetic signal caused by activities of the carrier, so as to generate orienting information corresponding to the carrier, a position sensing module for inferring the behavior mode of the carrier and performing error correction for the positioning information of the carrier according to the behavior mode, an orientation sensing module for correcting the electromagnetic signal and performing cross validation for the corrected electromagnetic signal and the positioning information, so as to perform error correction for the orienting information of the carrier, a data processing module for generating a location tag corresponding to the carrier, and a display module for displaying the positioning information, the orienting information, and/or the location tag. The map data server is used for providing map information. The waypoint server is connected to the navigation apparatus and the map data server through a wired/wireless network is used for requesting the map data server to provide the map information according to commands of the navigation apparatus, wherein the waypoint server comprises a capturing module for capturing/calculating/analyzing correspondingly a region map where the carrier is located from the map information supplied by the map data server according to the positioning information and the orienting information and sending the region map back to the navigation apparatus, so as to correspondingly generate the location tag of the carrier on the region map by the data processing module of the navigation apparatus according to the positioning information, to thereby display the region map by the display module and present the positioning information, the orienting information and/or the location tag on the region map for the carrier's reference.

In conclusion, the navigation apparatus and system of the present invention may correct errors in the positioning and orienting information of the carrier through the position sensing module and the orientation sensing module, and may generate corresponding route-planning information by using the positioning information and the orienting information analyzed and corrected by a route planning module, while being able to simultaneously display an instruction label corresponding to the route planning information and a real image of the location surrounding the carrier on the display module. Thereby, not only positioning accuracy substantially is improved over the prior art, but also the system can trigger carrier recognition of a location via the provision of the real image and, hence, to enable the carrier to rapidly decide which way to proceed.

### BRIEF DESCRIPTION OF DRAWINGS

The invention can be more fully understood by reading the following detailed description of the preferred embodiments, with reference made to the accompanying drawings, wherein:

FIG. 1 is an architecture drawing of a navigation apparatus for a first illustrative embodiment according to the present invention;

FIG. 2 is an architecture drawing of the navigation apparatus for a second illustrative embodiment according to the present invention;

FIG. 3A is an illustrative drawing of the typical route planning information supplied by the navigation apparatus according to the present invention;

FIG. 3B is an illustrative drawing of a typical display screen displayed by the navigation apparatus according to the present invention; and

FIG. 4 is an application system architecture drawing of a navigation system according to the present invention.

### DETAILED DESCRIPTION OF PREFERRED EMBODIMENTS

The following illustrative embodiments are provided to illustrate the disclosure of the present invention and its advantages, these and other advantages and effects being readily understood by those in the art after reading the disclosure of this specification. The present invention can also be performed or applied by other embodiments. The description of the specification presents specific details and applications, but numerous modifications and variations can be devised without departing from the spirit of the present invention.

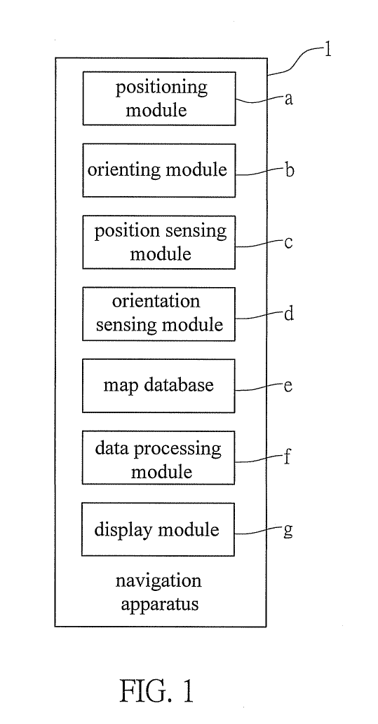

FIG. 1 shows an architecture drawing of a navigation apparatus for a first illustrative embodiment of the present invention. As illustrated, the navigation apparatus 1 comprises a positioning module a, an orienting module b, a position sensing module c, an orientation sensing module d, a map database e, a data processing module f, and a display module g. The navigation apparatus 1 is provided on a carrier (not shown), such as a pedestrian, a vehicle, a vessel or an aircraft.

The positioning module a receives and analyzes positioning signals sent from satellites, so as to generate positioning information corresponding to the carrier. Generally, the positioning module a is a signal receiver of a global positioning system (GPS). The positioning information is a location coordinate obtained by analyzing the positioning signals sent from the global positioning system. And the positioning information may comprise the advancing direction of the carrier in a high-speed moving condition. The orienting module b analyzes an electromagnetic signal caused by activities of the carrier, so as to generate orienting information corresponding to the carrier. For example, the orienting module b is a gyroscope, a magnetic compass, or a combination of these. The position sensing module c is used to infer a behavior mode of the carrier and perform error correction for the positioning information of the carrier according to the behavior mode, i.e. for the positioning information generated by the positioning module a according to the inferred behavior mode.

Specifically, the position sensing module c extracts characteristic values of the positioning information received and analyzed by the positioning module a, which represent a displacement value, a speed difference value, and/or a direction difference value of the carrier in unit time. Thereafter, the behavior state of the carrier is classified into a behavior mode, for example, a static mode, a linear velocity mode, a linear acceleration mode, a linear deceleration mode, a constant (isokinetic) turning mode, an accelerating turn mode, and/or a decelerating turn mode, while the probability value of the behavior mode is calculated by using the extracted characteristic values. After completing calculation, accumulating error due to inertial drift is corrected, and a state transition probability matrix of the carrier is calculated. Hence, drift error of the positioning information is corrected according to the state transition probability matrix. Therefore, the position sensing module c may adjust for error phenomenon of the positioning information, and thereby the positioning information is more accurate, particularly if the positioning module a is disturbed by the environment.

The orientation sensing module d corrects the electromagnetic signal, and the corrected electromagnetic signal and the positioning information generated by the positioning module a are cross validated so as to correct error of the orienting information generated by the orienting module b. In an illustrative embodiment, magnetic error correction is performed according to rigid steering motion characteristics of the carrier by the orientation sensing module d. Moreover, such adjustment, that is, the corrected electromagnetic signal cross-validated with the positioning information generated by the positioning module a, means that the corrected electromagnetic signal is analyzed and/or calculated by using a magnetic analysis and/or an orientation algorithm in order to gather difference information of the continuous electromagnetic signal, so as to correct error of the orienting information of the carrier. By way of the previously described adjusting procedure, the orienting information generated by the orienting module b tends to be much more precise.

The map database e is used to provide map information selectively comprising figures, voice, images, characters, and/or symbols. The data processing module f is used to capture a corresponding region map from the map information of the map database e according to the corrected positioning information and the corrected orienting information, and to generate marks on the region map corresponding to the position of the carrier. For example, the data processing module f captures the region map from the map information by selectively using figure recognition technology, voice recognition technology, image recognition technology, character recognition technology, and symbol recognition technology, and generates, for example, a flashing highlight or a location tag in virtual model, so as to represent the immediate location of the carrier. The display module g is used to display the region map captured by the data processing module f and to display the corrected positioning information, the corrected orienting information, and/or the generated location tag that can be superimposed on the region map. The display module g may be, for example, an LCD display, an LED display, or a flat-panel display comprising an image processing and playing chip.

In operation, after switching on the navigation apparatus 1 of the present invention, the navigation apparatus 1 infers the accurate positioning information and orienting information by using the combined operations of the positioning module a, the orienting module b, the position sensing module c, and the orientation sensing module e. Then, by the data processing module f, it captures the region map according to the inferred positioning information and the orienting information, and superimposes the location tag on the region map, so as to be displayed by the display module g. The display module g enables the positioning information and the orienting information to appear on the region map concurrently. Hence, the low accuracy problem in the prior art is completely resolved by the present invention.

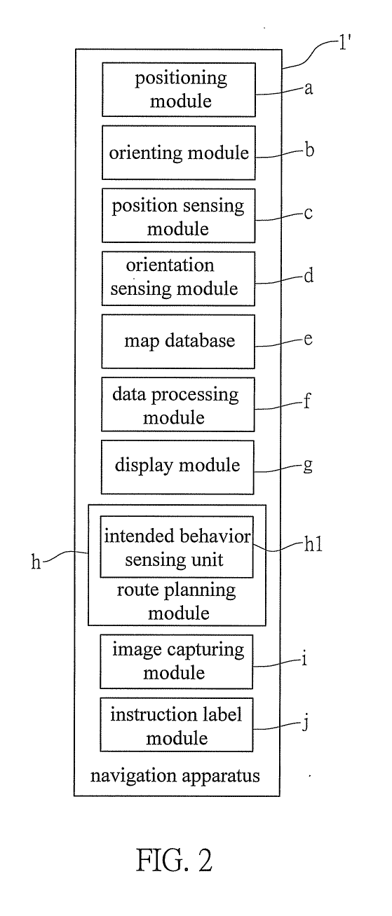

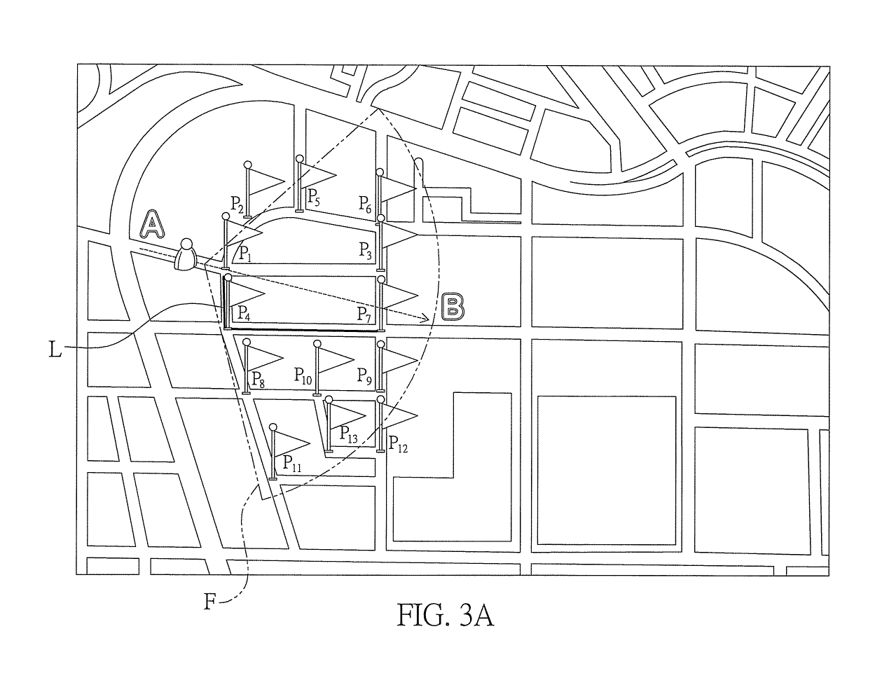

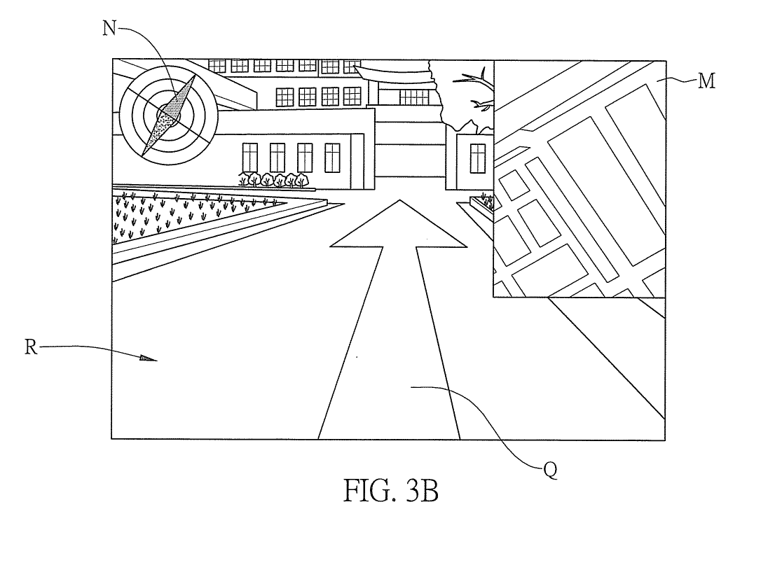

FIG. 2 shows an architecture drawing of the navigation apparatus for a second illustrative embodiment of the present invention. As illustrated, a navigation apparatus 1′ comprises the elements of the navigation apparatus 1 of the first illustrative embodiment but further comprises a route planning module h, an image capturing module i, and an instruction label module j, wherein the route planning module h analyzes location information marked by the data processing module f according to user-set destination information, so as to generate route planning information corresponding to the region map. FIG. 3A shows an illustrative drawing of typical route planning information in order to illustrate the actuation method of the route planning module h.

In FIG. 3A, a location point A of the user represents the location tag and a direction tag generated by the position sensing module c and the orientation sensing module d, respectively (the immediate location and direction of the carrier), and a bisection point B of a centerline of a sector sketched on the basis of the location point A as a center represents a temporary starting point. Therefore, the route planning module h indicates an appropriate region area (i.e. a fan-shaped advancing region F) in the region map by making use of the location point A and the bisection point B, wherein the location point A is considered as a starting point by the route planning module h. The route planning module h further analyzes the advancing region F, forms a street intersection list (intersections P1-P13) spanned by the advancing region F, and then an appropriate recommended route (route L) is inferred therefrom. In the illustrative embodiment, the intersections P1, P4, P7 passed by the route L are defined as midway points. Also, the shape and area of the advancing region F may be regulated according to the corrected positioning information and the corrected orienting information, and the number of recommended routes may be increased according to the requirements or preferences of the user.

Next, the route planning module h may selectively comprise an intended behavior sensing unit h1 used for continuously analyzing the positioning information, the orienting information, the destination information, and the route planning information during a predetermined period of time, so as to infer the intended behavior information of the carrier. Thereby, the route planning information is further updated according to the inferred intended behavior information selectively by the route planning module h, so as to keep the latest route planning information at any time. In particular, the intended behavior sensing unit h1 calculates a speed difference value V and a distance difference value D of the carrier in unit time by using the positioning information, the orienting information, the destination information, and the route planning information to thereby infer the intended behavior information of the carrier. Specifically, the location point A is assumed as the starting point, while the distance difference value D is defined by the location point A and the closest midway point (intersection P1), and an angle difference value Θ is defined by the orienting information and the closest midway point (intersection P1) in unit time. The carrier is inferred to be following the route L to advance by the intended behavior sensing unit h1 when the distance difference value D and the angle difference value Θ decrease progressively as time goes by. Conversely, the carrier is inferred to be deviated from the route L to advance by the intended behavior sensing unit h1 when the distance difference value D and the angle difference value Θ increase progressively as time goes by. Therefore, the route planning information is updated by the route planning module h to provide the newest recommended route. It is worth mentioning that, since the speed difference value V of the carrier is defined by the variation of the positioning information and the orienting information in unit time, the speed difference value V of the carrier is assumed to be determined. The intended behavior sensing unit h1 may further perform detailed behavior judgments according to the speed difference value V when the carrier is already determined to be deviated from the route L by the intended behavior sensing unit h1. For instance, the carrier may be considered as being in a lost state if the speed difference value V progressively decreases; conversely, the carrier may be considered as being in an non-lost state if the speed difference value V doesn't vary or progressively increases, wherein, at this time, the intended behavior sensing unit h1 may further ask the route planning module h to update the route planning information. Therefore, the present invention provides more flexible usage to avoid frequent updating of the route planning information which may contribute to the information disorder and the increased power usage.

Additionally, the image capturing module i is used to capture a real image surrounding the carrier, wherein the image capturing module i may be a digital camcorder, a digital camera, an infrared lens, or a CCD lens, and the like device. The instruction label module j is used to generate an instruction label according to the route planning information generated by the route planning module h, the positioning information corrected by the position sensing module c, and the orienting information corrected by the orientation sensing module d, so as to display the real image captured by the image capturing module g by the display module g, and to correspondingly show the generated instruction label on the real image displayed by the display module g. In other words, the real image and the instruction label may be shown simultaneously.

FIG. 3B depicts an illustrative drawing of a typical display screen in order to illustrate the real image having the instruction label displayed by the display module g. In FIG. 3B, a background image R represents the real image captured by the image capturing module i, a guide arrow Q represents the instruction label generated by the instruction label module j, and the guide arrow Q may indicate the next closest midway point. In the illustrative embodiment, the indication of the guide arrow Q may vary, for instance, in the state of bending right, bending left, turning right, or turning left, according to the relationship between the positioning information and the next midway point. In FIG. 3B, an inset M may represent the region map captured by the data processing module f, and an indicator N may represent compass directions in the real environment. Of course, the speed of the carrier per hour may also be calculated and displayed according to the variation of the corrected positioning information in unit time.

Compared with the prior art, since the display screen displayed by the display module g is the combination of the real image and the instruction label generated by the instruction label module j, the understanding and certainty of the user may be increased. Since the instruction label may indicate the next midway point, a direction to be followed may be provided to the user in timely fashion. Moreover, the defects of the prior navigation screen are completely avoided. The position sensing module c, the orientation sensing module d, the data processing module f, the route planning module h, the intended behavior sensing unit h1, and the instruction label module j may be implemented in hardware as integrated circuits or software having logical calculus functions. In application, the navigation apparatus 1 may selectively comprise the route planning module h and the intended behavior sensing unit h1.

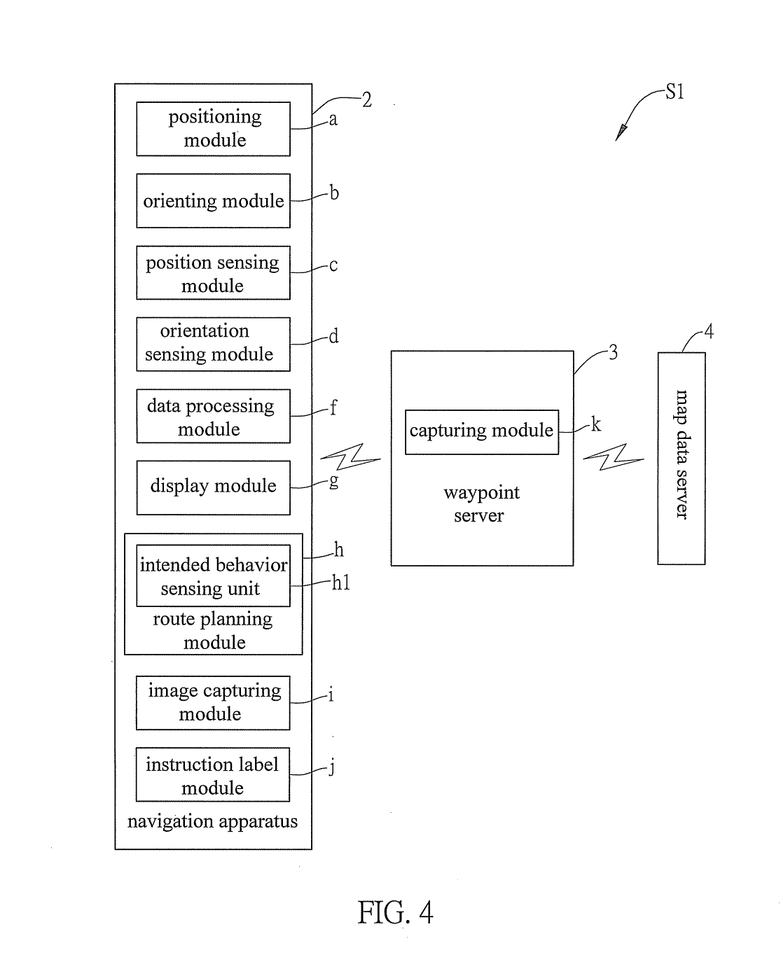

FIG. 4 shows an application system architecture drawing of a navigation system of the present invention. As illustrated, the navigation system Si comprises a navigation apparatus 2, a waypoint server 3, and a map data server 4 interconnected through wired/wireless network connections (not shown), and the navigation apparatus 2 may be provided on a pedestrian, a vehicle, a vessel, an aircraft, and similar carrier, wherein the navigation apparatus 2 is used to provide for the carrier positioning and navigation functions, and comprises the positioning module a, the orienting module b, the position sensing module c, the orientation sensing module d, the data processing module f, the display module g, the route planning module h, the intended behavior sensing unit h1, the image capturing module i, and the instruction label module j, as with the navigation apparatus 1(1′). Herein, the data processing module f is only used to generate the corresponding location tag of the carrier.

The map data server 4 is used to provide the same map information as the map database e or more detailed information. In the illustrative embodiment, the map data server 4 may be, for example, an online map website such as Google Maps. The waypoint server 3 is provided in an Internet room of an Internet Service Provider or similar, and has a capturing module k capturing/calculating/analyzing the corresponding region map where the carrier is located from the map information supplied by the map data server 4 according to the positioning information and the orienting information. The capturing module k sends the region map back to the navigation apparatus 2, so as to generate the corresponding location tag of the carrier on the region map by the data processing module f according to the positioning information. Thereby, the display module g may display the region map, and enable the positioning information, the orienting information and/or the location tag to be presented on the region map.

Comparing the navigation apparatus 2 with the navigation apparatus 1(1′), since there is no need for the map database e, capacity may be saved. In addition, in terms of the data processing module f, since there is no need for capturing the region map as in the previously illustrated embodiment, resources may be saved. In an illustrative aspect, the route planning module h, the intended behavior h1, the image capturing module i, and the instruction label module j may selectively be not included in the navigation apparatus 2. Furthermore, it should be noted that, herein, the route planning module h and the intended behavior sensing unit h1 may be provided separately. That is, the route planning module h is provided in the waypoint server3, and the intended behavior sensing unit h1 is provided in the navigation apparatus 2. The benefit is that the detailed route planning information is provided, and computing resources of the navigation apparatus 2 are further saved by virtue of the waypoint server 3 having more powerful computing functionality.

In conclusion, the navigation apparatus and system of the present invention may correct errors in the positioning information and the orienting information of the carrier through the position sensing module and the orientation sensing module, and may generate corresponding route planning information by using the positioning information and the orienting information analyzed and corrected by the route planning module, while being able to simultaneously display an instruction label corresponding to the route planning information and a real image of the surroundings of the carrier on the display module. Thereby, not only are the defects of the prior art substantially improved, including low positioning accuracy, but also the location recognition of the user is increased via the display screen supplied by the navigation apparatus, hence, enabling the user to rapidly decide which way to proceed.

The foregoing descriptions of the detailed embodiments are illustrated to disclose the features and functions of the present invention and are not intended to be restrictive of the scope of the present invention. It should be understood by those in the art that many modifications and variations can be made within the spirit and principles of the disclosure of the present invention such that they fall within the scope of the appended claims.

What is claimed is:

1. A navigation apparatus for use in a mobile carrier, comprising:
a positioning module for receiving and analyzing positioning signals sent from satellites, so as to generate positioning information corresponding to the carrier;
an orienting module for analyzing an electromagnetic signal caused by activities of the carrier, so as to generate orienting information corresponding to the carrier;
a position sensing module for inferring a behavior mode of the carrier and performing error correction for the positioning information of the carrier according to the behavior mode;
an orientation sensing module for correcting the electromagnetic signal and performing cross validation for the corrected electromagnetic signal and the positioning information, so as to perform error correction for the orienting information of the carrier;
a map database for providing map information;
a data processing module for capturing a region map correspondingly from the map information according to the positioning information and the orienting information and generating a location tag corresponding to the carrier on the region map; and
a display module for displaying the region map and presenting the positioning information, the orienting information, and/or the location tag on the region map.

2. The apparatus of claim 1, wherein the position sensing module extracts characteristic values from the positioning information, so as to infer the different behavior modes of the carrier, and calculates a state transition probability matrix of the carrier according to probability values of the behavior modes, so as to perform drift error correction for the positioning information, wherein the characteristic values are a displacement value, a speed difference value, and/or a direction difference value of the carrier in unit time, and the different behavior modes of the carrier are a static mode, a linear velocity mode, a linear acceleration mode, a linear deceleration mode, a constant turn mode, an accelerating turn mode, and/or a decelerating turn mode.

3. The apparatus of claim 1, wherein the orientation sensing module performs magnetic error correction for the electromagnetic signal according to a rigid steering motion characteristic of the carrier, and performs cross validation for the corrected electromagnetic signal and the positioning information, so as to perform error correction for the orienting information of the carrier, wherein cross validation methods comprise using a magnetic analysis method and/or an orientation algorithm to perform analysis and/or calculation for the corrected electromagnetic signal, so as to gather difference information to thereby perform error correction for the orienting information of the carrier.

4. The apparatus of claim 1, further comprising a route planning module for analyzing the location tag of the carrier according to predetermined destination information, so as to generate route planning information corresponding to the region map, wherein the route planning module comprises an intended behavior sensing unit for continuously analyzing the positioning information, the orienting information, the destination information, and the route planning information during a predetermined period of time, so as to infer the intended behavior information of the carrier to thereby update the route planning information selectively according to the intended behavior information, wherein the intended behavior sensing unit calculates a speed difference value and a distance difference value of the carrier in unit time by using the positioning information, the orienting information, the destination information, and the route planning information, to thereby infer likely movement of the carrier according to the speed difference value and the distance difference value.

5. The apparatus of claim 4, further comprising:
an image capturing module for capturing a real image of a location surrounding the carrier; and
an instruction label module for generating an instruction label correspondingly according to the route planning information, the positioning information, and the orienting information of the carrier, so as to display the real image by the display module and show an instruction label on the real image.

6. The apparatus of claim 5, wherein the position sensing module, the orientation sensing module, the data processing module, the route planning module, the intended behavior sensing unit, and the instruction label module are constructed by software.

7. A navigation system comprising:
a navigation apparatus provided on a mobile carrier for providing position and navigation, wherein the navigation apparatus comprises:
a positioning module for receiving and analyzing positioning signals sent from satellites, so as to generate positioning information corresponding to the carrier;
an orienting module for analyzing an electromagnetic signal caused by activities of the carrier, so as to generate orienting information corresponding to the carrier;
a position sensing module for inferring a behavior mode of the carrier and performing error correction for the positioning information of the carrier according to the behavior mode;
an orientation sensing module for correcting the electromagnetic signal and performing cross validation for the corrected electromagnetic signal and the positioning information, so as to perform error correction for the orienting information of the carrier;
a data processing module for generating a location tag corresponding to the carrier; and
a display module for displaying the positioning information, the orienting information, and/or the location tag;
a map data server for providing map information; and
a waypoint server connected to the navigation apparatus and the map data server through a network for requesting the map data server to provide the map information according to commands of the navigation apparatus, wherein the waypoint server comprises:
a capturing module for capturing/calculating/analyzing correspondingly a region map where the carrier is located from the map information supplied by the map data server according to the positioning information and the orienting information and sending the region map back to the navigation apparatus, so as to correspondingly generate the location tag of the carrier on the region map by the data processing module of the navigation apparatus according to the positioning information, to thereby display the region map by the display module and present the positioning information, the orienting information and/or the location tag on the region map.

8. The system of claim 7, wherein the position sensing module extracts characteristic values from the positioning information, so as to infer the different behavior modes of the carrier, and calculates a state transition probability matrix of the carrier according to probability values of behavior modes, so as to perform drift error correction for the positioning information, wherein the characteristic values are a displacement value, a speed difference value, and/or a direction difference value of the carrier in unit time, and the different behavior modes of the carrier are a static mode, a linear velocity mode, a linear acceleration mode, a linear deceleration mode, a constant turn mode, an accelerating turn mode, and/or a decelerating turn mode.

9. The system of claim 8, wherein the orientation sensing module performs magnetic error correction for the electromagnetic signal according to a rigid steering motion characteristic of the carrier, and performs cross validation for the corrected electromagnetic signal and the positioning information, so as to perform error correction for the orienting information of the carrier, wherein cross validation methods comprise using a magnetic analysis and/or an orientation algorithm to perform analysis and/or calculation for the corrected electromagnetic signal, so as to gather difference information to thereby perform error correction for the orienting information of the carrier.

10. The system of claim 7, wherein the navigation apparatus further comprises a route planning module for analyzing the location tag of the carrier according to predetermined destination information, so as to generate route planning information corresponding to the region map, wherein the route planning module comprises an intended behavior sensing unit for continuously analyzing the positioning information, the orienting information, the destination information, and the route planning information during a predetermined period of time, so as to infer the intended behavior information of the carrier, to thereby update the route planning information selectively according to the intended behavior information, wherein the intended behavior sensing unit calculates a speed difference value and a distance difference value of the carrier in unit time by using the positioning information, the orienting information, the destination information, and the route planning information, so as to infer likely movement of the carrier according to the speed difference value and the distance difference value.

11. The system of claim 10, wherein the navigation apparatus further comprises an image capturing module and an instruction label module, wherein the image capturing module captures a real image of the location surrounding the carrier, the instruction label module generates an instruction label correspondingly according to the route planning information, the positioning information, and the orienting information of the carrier, so as to display the real image by the display module and show an instruction label on the real image.

12. The system of claim 11, wherein the position sensing module, the orientation sensing module, the data processing module, the route planning module, the intended behavior sensing unit, and the instruction label module are constructed by software.
